(19) United States
(12) Patent Application Publication
(10) Pub. No.: US 2026/0124911 A1
(43) Pub. Date: May 7, 2026

(54) VEHICLE CONTROL APPARATUS

(71) Applicant: TOYOTA JIDOSHA KABUSHIKI KAISHA, Toyota-shi (JP)

(72) Inventor: Masayuki YAMAZAKI, Yokohama-shi (JP)

(73) Assignee: TOYOTA JIDOSHA KABUSHIKI KAISHA, Toyota-shi (JP)

(21) Appl. No.: 19/374,302

(22) Filed: Oct. 30, 2025

(30) Foreign Application Priority Data
Nov. 5, 2024 (JP) 2024-193978

(51) Int. Cl. B60K 28/06; B60R 25/04; G06V 20/59

(52) U.S. Cl. CPC B60K 28/063; B60R 25/04; G06V 20/597

(57) ABSTRACT

A vehicle control apparatus includes a controller and an imager that captures an image of an interior of a vehicle. The controller acquires the image from the imager, detects an object from the image using an object detection technique, calculates a movement amount of the object from the image, estimate a depth difference between a depth from the imager to a hand of the object and a depth from the imager to posture stabilization equipment when at least a part of the hand is located within a detection area including the posture stabilization equipment and the movement amount is not greater than a movement amount threshold, and turns on a flag indicating that a posture of the object is a safe posture when the depth difference is not greater than the depth difference threshold, and turns off the flag when the depth difference is greater than the depth difference threshold.

### CROSS-REFERENCE TO RELATED APPLICATION

This application claims priority to Japanese Patent Application No. 2024-193978 filed on Nov. 5, 2024, the entire contents of which are incorporated herein by reference.

### TECHNICAL FIELD

The present disclosure relates to a vehicle control apparatus.

### BACKGROUND

Technology for estimating the posture of an object is known. For example, Patent Literature (PTL) 1 discloses technology related to a method and apparatus that can simultaneously predict object recognition and position posture using machine learning.

### CITATION LIST

### Patent Literature

PTL 1: JP 2019-029021 A

### SUMMARY

When posture judgment is used to determine permission to start a vehicle, it is desirable to determine that the posture of an occupant in the vehicle is a safe posture, for example, a grasping posture in which a handrail or the like is grasped. Judgment of the grasping posture by image recognition is mainly performed using machine learning. However, judgment by machine learning may require a large amount of training data and high computational costs to adapt to changes in patterns of gloves and handrails, as well as environmental characteristics such as the vehicle's interior.

It would be helpful to improve technology for estimating the posture of an object.

A vehicle control apparatus according to an embodiment of the present disclosure includes:
a controller; and
an imager configured to capture an image of an interior of a vehicle, and the controller is configured to:
   acquire the image of the interior of the vehicle from the imager;
   detect an object from the image using an object detection technique;
   calculate a movement amount of the object from the image;
   estimate a depth difference between a depth from the imager to a hand of the object and a depth from the imager to posture stabilization equipment in a case in which at least a part of the hand of the object is located within a detection area including the posture stabilization equipment and the movement amount of the object is equal to or less than a movement amount threshold; and
   turn on a flag indicating that a posture of the object is a safe posture in a case in which the depth difference is equal to or less than the depth difference threshold, and turn off the flag in a case in which the depth difference is greater than the depth difference threshold.

According to an embodiment of the present disclosure, technology for estimating the posture of an object is improved.

### BRIEF DESCRIPTION OF THE DRAWINGS

In the accompanying drawings:

FIG. 1 is a block diagram illustrating a schematic configuration of a system according to an embodiment of the present disclosure; and

FIG. 2 is a flowchart illustrating operations of a vehicle control apparatus according to the present embodiment.

### DETAILED DESCRIPTION

Embodiments of the present disclosure will be described below, with reference to the drawings.

### Outline of Present Embodiment

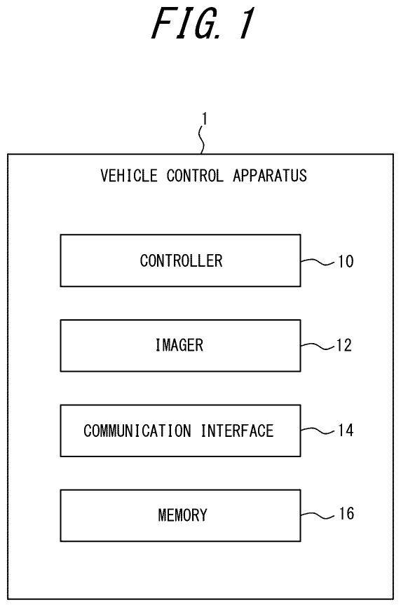

With reference to FIG. 1, an overview of the vehicle control apparatus 1 according to the embodiment of the present disclosure will be described. The vehicle control apparatus 1 is an electronic device mounted on the vehicle, such as a computer. The vehicle control apparatus 1 detects an object from an image inside the vehicle using any object detection technique. The image may be a still image or a moving image. The object is an occupant inside the vehicle.

The vehicle is any vehicle capable of carrying one or more occupants, such as an automobile, bus, or shuttle bus. The vehicle may be an automated driving vehicle capable of automated driving at levels 1 to 5 as defined by the Society of Automotive Engineers (SAE). The vehicle may be a manually operated vehicle at level 0. The vehicle may be monitored remotely by an observer outside the vehicle. The vehicle may be a Mobility as a Service (MaaS) dedicated vehicle.

First, an outline of the present embodiment will be described, and details thereof will be described later. The vehicle control apparatus 1 according to the present embodiment includes a controller 10 and an imager 12 that captures images inside the vehicle. The controller 10 acquires images inside the vehicle from the imager 12. The controller 10 detects an object from the image using an object detection technique. The controller 10 calculates the movement amount of the object from the image. When at least a part of the object's hand is positioned within a detection area that includes posture stabilization equipment, and the movement amount of the object is equal to or less than a movement amount threshold, the controller 10 estimates the depth difference between the object's hand and the imager 12, and the depth from the imager 12 to the posture stabilization equipment. If the depth difference is equal to or less than the depth difference threshold, the controller 10 turns ON a flag indicating that the posture of the object is a safe posture, and if the depth difference is greater than the depth difference threshold, it turns OFF the flag.

According to the present embodiment, it becomes possible to determine the grasping of posture stabilization equipment (for example, handrails or straps) at a lower cost than a machine learning approach through a measurement approach using human detection and depth estimation.

### Configuration of Vehicle Control Apparatus 1

The vehicle control apparatus 1 includes a controller 10, an imager 12, a communication interface 14, and a memory 16. These parts are communicably connected to each other via an in-vehicle network, such as a Controller Area Network (CAN), or a dedicated line.

The controller 10 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing. The controller 10 executes processes related to operations of the vehicle control apparatus 1 while controlling components of the vehicle control apparatus 1.

The imager 12 is any imaging module that is installed in the vehicle and can image part or all of the seats and objects inside the vehicle. The imaging module includes one or more cameras. In this embodiment, the imager 12 is a single camera installed on the ceiling of the vehicle. In this embodiment, the imager 12 captures RGB images. The imager 12 may include a depth sensor that acquires depth images or a ranging device such as a stereo camera.

The communication interface 14 includes at least one interface for communication to connect to the in-vehicle network. The interface for communication is compatible with, for example, mobile communication standards such as 4th generation (4G) or 5th generation (5G), V2X (vehicle-to-everything) communication standards such as dedicated short range communications (DSRC) or cellular V2X, or wireless local area network (LAN) communication standards such as Institute of Electrical and Electronics Engineers 802.11 (IEEE 802.11).

The memory 16 includes one or more memories. Various memories included in the memory 16 may function as, for example, a main memory, an auxiliary memory, or a cache memory. The memory 16 stores any information used for operations of the vehicle control apparatus 1. For example, the memory 16 stores system programs, application programs, embedded software, and any data used for object detection and posture estimation. In this embodiment, the memory 16 pre-stores a detection area that includes posture stabilization equipment. As a result, it is no longer necessary to set the detection area each time the position of the object's hand is determined, reducing the processing burden on the vehicle control apparatus 1. The detection area is, for example, a two-dimensional area on an image. Posture stabilization equipment refers to facilities that can be grasped by a person to stabilize their posture, such as handrails and straps. The size of the detection area may be set according to the type of posture stabilization equipment. For example, if the posture stabilization equipment is movable like a strap, the detection area may be set to encompass the range of motion of the posture stabilization equipment. In this embodiment, the memory 16 pre-stores the depth from the imager 12 to the posture stabilization equipment. As a result, the processing burden on the vehicle control apparatus 1 is reduced. The information stored in the memory 16 may be updated with information acquired from the in-vehicle network or an external network via the communication interface 14. In the present embodiment, the state of a flag indicating that the object is holding the posture stabilization equipment (ON or OFF) is updated by the controller 10 and also stored in the memory 16.

In the present embodiment, the memory 16 stores an object detection AI that detects the object and the skeleton of the object included in the image, and a depth estimation AI that estimates the depth from the imager 12 to the subject. The skeleton and depth can be detected from the RGB image. To improve accuracy, depth images may also be used in conjunction with the detection of the skeleton. The object detection AI may include any object detection model such as You Only Look Once (YOLO) or Convolutional Neural Network (CNN). The depth estimation AI may include any depth estimation model.

### Flow of Operations of Vehicle Control Apparatus 1

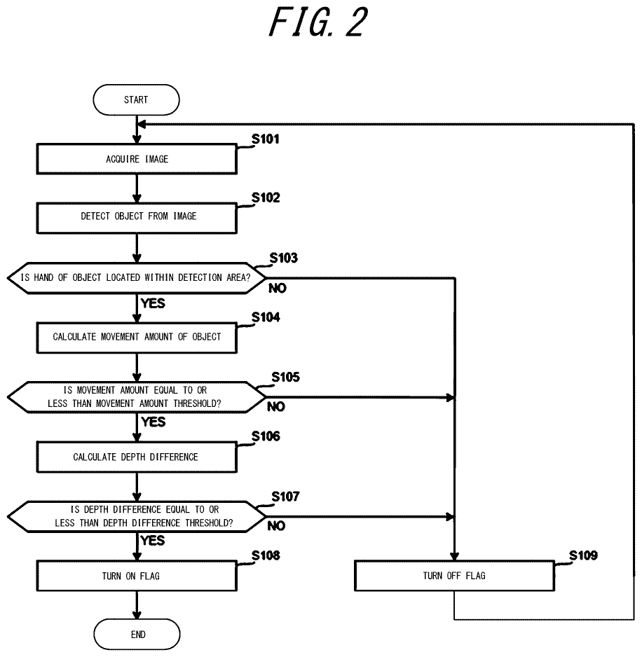

Operations of the vehicle control apparatus 1 according to the present embodiment will be described with reference to FIG. 2. The controller 10 determines whether the posture of each object in the vehicle is a safe posture by executing the following S101 to S108 while the vehicle is temporarily stopped at a stop. In the following, communication between the various parts of the vehicle control apparatus 1 is performed via the communication interface 14 and the in-vehicle network.

S101: The controller 10 of the vehicle control apparatus 1 acquires an image captured by the imager 12.

S102: The controller 10 detects the object from the image using an object detection technique.

The controller 10 inputs the image captured by the imager 12 into the object detection AI stored in the memory 16 in advance. The object detection AI detects the presence of the object in the image and the skeleton of the object based on the input image.

S103: The controller 10 determines whether at least a part of the object's hand is located within the detection area that includes the posture stabilization equipment. If at least a part of the object's hand is located within the detection area (S103—YES), the process proceeds to S104. If the object's hand is not located within the detection area (S103—NO), the process proceeds to S109.

In S103, based on the position of the object's hand, a determination is made as to whether the object is holding the posture stabilization equipment. If the object is holding the posture stabilization equipment, the posture of the object can be considered a safe posture. If at least a part of the hand of the object is located within the detection area, it is highly likely that the object is grasping the posture stabilization equipment. The controller 10 may determine that at least a part of the hand is located within the detection area if the joints of the hand or wrist of the object's skeleton are continuously located within the detection area for at least 2 frames.

S104: The controller 10 calculates a movement amount of the object from the image.

The controller 10 may calculate the movement amount of the object, that is, the movement amount of the entire body of the object, by calculating the movement amount per unit time of each feature point (for example, joints) in the object's skeleton and summing the movement amounts per unit time of all feature points. When summing the movement amounts of all feature points, different weighting coefficients may be assigned to each feature point.

S105: The controller 10 determines whether the movement amount of the object is equal to or less than the movement amount threshold. If the movement amount of the object is equal to or less than the movement amount threshold (S105—YES), the process proceeds to S106. If the movement amount of the object is greater than the movement amount threshold (S105—NO), the process proceeds to S109.

In S105, a determination of a safe posture based on the movement amount of the object is performed. When the object is stationary or when the movement amount of the object is small, it is more likely that the object is safe than when the object is moving.

S106: The controller 10 estimates the depth difference between the depth from the imager 12 to the hand of the object and the depth from the imager 12 to the posture stabilization equipment.

The controller 10 inputs the image into the depth estimation AI stored in the memory 16 in advance. The depth estimation AI estimates the depth difference based on the input image. The depth from the imager 12 to the hand may be calculated from the coordinates of the hand in the image depth map or from the skeletal coordinates of the hand or wrist joints.

S107: The controller 10 determines whether the depth difference is equal to or less than the depth difference threshold. If the depth difference is equal to or less than the depth difference threshold (S107—YES), the process proceeds to S108. If the depth difference is greater than the depth difference threshold (S107—NO), the process proceeds to S109.

In S107, a determination is made based on the depth difference whether the object is grasping the posture stabilization equipment. At the time of S107, at least a part of the hand is determined to be located within the detection area (see S103). Therefore, if the depth difference is equal to or less than the depth difference threshold, the depth difference between the hand and the posture stabilization equipment can be considered small, making it even more likely that the object is grasping the posture stabilization equipment.

S108: The controller 10 turns on the flag indicating that the posture of the object is a safe posture. The process then ends.

If the object is holding the posture stabilization equipment or if the movement amount of the object is small, the posture of the object can be considered a safe posture.

S109: The controller 10 turns off the flag. The process subsequently returns to S101.

The controller 10 repeats S101 to S109 until the flag is turned on.

The controller 10 executes the processes from S101 to S109 for each object in the vehicle. If the flag is turned on for all objects, the controller 10 permits the vehicle to start. If the flag is turned off for at least one object, the controller 10 does not permit the vehicle to start.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided. For example, in the above embodiment, an embodiment in which the configuration and operations of the vehicle control apparatus 1 are distributed to multiple computers or devices capable of communicating with each other can be implemented. Additionally, for example, in the above embodiment, it is also possible to provide the imager 12 as a separate device from each part of the vehicle control apparatus 1.

In the above embodiment, the determinations in S103, S105, and S107 may be performed in any order. For example, after determining whether the object is holding the posture stabilization equipment in S103 and S107, the determination of a safe posture based on the movement amount of the object in S105 may be performed. Furthermore, when the controller 10 of the vehicle control apparatus 1 permits the vehicle to start, it may start the vehicle by executing automatic driving control of the vehicle. Moreover, the vehicle control apparatus 1 may be used to provide Mobility as a Service (MaaS), a service that leverages mobility.

1. A vehicle control apparatus comprising
a controller; and
an imager configured to capture an image of an interior of a vehicle,
wherein the controller is configured to:
acquire the image of the interior of the vehicle from the imager;
detect an object from the image using an object detection technique;
calculate a movement amount of the object from the image;
estimate a depth difference between a depth from the imager to a hand of the object and a depth from the imager to posture stabilization equipment in a case in which at least a part of the hand of the object is located within a detection area including the posture stabilization equipment and the movement amount of the object is equal to or less than a movement amount threshold; and
turn on a flag indicating that a posture of the object is a safe posture in a case in which the depth difference is equal to or less than the depth difference threshold, and turn off the flag in a case in which the depth difference is greater than the depth difference threshold.

2. The vehicle control apparatus according to claim 1, wherein the controller is configured to turn off the flag in a case in which at least a part of the hand of the object is not located within the detection area, or in a case in which the movement amount of the object is greater than the movement amount threshold.

3. The vehicle control apparatus according to claim 1, wherein the vehicle is an automated driving vehicle.

4. The vehicle control apparatus according to claim 1, wherein the posture stabilization equipment is a handrail or a strap.

5. The vehicle control apparatus according to claim 1, wherein the controller is configured to:
permit the vehicle to start in a case in which the flag is turned on for all objects in the vehicle; and
not permit the vehicle to start in a case in the flag is turned off for at least one object in the vehicle.

6. The vehicle control apparatus according to claim 2, wherein the controller is configured to:
permit the vehicle to start in a case in which the flag is turned on for all objects in the vehicle; and
not permit the vehicle to start in a case in the flag is turned off for at least one object in the vehicle.

7. The vehicle control apparatus according to claim 3, wherein the controller is configured to:
permit the vehicle to start in a case in which the flag is turned on for all objects in the vehicle; and
not permit the vehicle to start in a case in the flag is turned off for at least one object in the vehicle.

8. The vehicle control apparatus according to claim 4, wherein the controller is configured to:
permit the vehicle to start in a case in which the flag is turned on for all objects in the vehicle; and
not permit the vehicle to start in a case in the flag is turned off for at least one object in the vehicle.

9. A method, by a processor, for improving travel mobility as a service (MaaS), comprising processing steps executed by the vehicle control apparatus according to claim 1.
